(19) United States
(12) Patent Application Publication
(10) Pub. No.: US 2015/0336121 A1
(43) Pub. Date: Nov. 26, 2015

(54) Anti-icing fluid spraying method and device.

(71) Applicant: Walter Randa, St-Colomban (CA)

(72) Inventor: Walter Randa, St-Colomban (CA)

(21) Appl. No.: 14/719,955

(22) Filed: May 22, 2015

Related U.S. Application Data
(60) Provisional application No. 62/003,005, filed on May 26, 2014.

(51) Int. Cl. B05B 7/24; B64F 5/00

(52) U.S. Cl. CPC B05B 7/2494; B64F 5/0063; B05B 7/2491

(57) ABSTRACT

A device and method for spraying anti-icing fluid on an airplane. The anti-icing fluid is contained in a tank defining a tank lowest portion. The device and method use compressed air to push the anti-icing fluid through a tube provided in the tank and opening adjacent to the tank lowest portion. The tube extends in a generally upward direction to a tank fluid outlet. A hose extends from the tank fluid outlet to a spray gun that is used for spraying the fluid.

### FIELD OF THE INVENTION

The present invention relates to the general field of aviation and is particularly concerned with an anti-icing fluid spraying method and device.

### BACKGROUND

Deicing and anti-icing fluids, collectively referred to in this document as anti-icing fluids, are sprayed on airplanes before takeoff in some weather conditions. Large commercial airplanes are sprayed using deicing/anti-icing stations including special-purpose trucks in which a nozzle is connected to a tank containing the anti-icing fluid with a hose. To minimize spraying time for each airplane, relatively large quantities of fluid are applied, which results in waste as a significant portion of the fluid falls on the ground. Most airports allow private planes owners to use the deicing/anti-icing stations, but the costs of doing so are relatively large.

There have been some systems developed for spraying the wings of private airplanes with anti-icing fluids. However, these systems use typically an electrically powered pump and as such have two main disadvantages. The first one is that it takes a relatively long time to spray even moderately large airplanes. Since anti-icing fluids are often relatively unstable with a useful lifetime of the order of 60 to 90 minutes, long spraying times only leave a small window during which the airplane car take off. Since at large airports commercial airlines typically have priority in runway access, it can happen that the airplane cannot take off before the anti-icing fluid has degraded, which requires that the airplane be first cleaned from the degraded anti-icing fluid to be afterward resprayed. In addition to being inconvenient, this operation can be costly as the fluid itself can be expensive, and the airplane crew needs to be paid for the waiting time until the airplane is ready to takeoff.

Another disadvantage is that electrical pump can create shear forces in the anti-icing fluid while it is pumped therethrough, which can partially degrade the anti-icing fluid. The anti-icing fluid thus applied is less efficient for its intended purpose, and it will also degrade to a point at which it becomes unsuitable in a shorter amount of time than intact anti-icing fluid.

Accordingly, there exists a need for an improved method and device for spraying anti-icing fluid. It is a general objective of the present invention to provide such an improved device and an improved method.

### SUMMARY OF THE INVENTION

In a broad aspect, the invention provides an anti-icing fluid sprayer usable with a compressed air source for spraying airplane anti-icing fluid on an airplane, the anti-icing fluid sprayer comprising: a tank for holding the airplane anti-icing fluid, the tank defining a tank lower portion, a tank upper portion and a tank intermediate portion therebetween, the tank defining tank air inlet and outlet and tank fluid inlet and outlet, the tank fluid outlet being in the tank upper portion, the tank including a drawing tube extending between the tank fluid outlet and the tank lower portion, the tank air inlet being connectable to the compressed air source; a spray gun for spraying the airplane anti-icing fluid; and a hose extending between the tank fluid outlet and the spray gun. Pressurizing the tank with compressed air from the compressed air source forces the airplane anti-icing fluid out of the tank towards the spray gun.

In another broad aspect, the invention provides a method for spraying airplane anti-icing fluid on an airplane, the method comprising: providing a tank in which the airplane anti-icing fluid is contained, the tank being pressurized with a gas; drawing the anti-icing fluid from the tank under the action of pressure exerted by the gas; and spraying the anti-icing fluid from the tank.

Advantageously, the proposed device and method reduce or eliminate anti-icing fluid degradation due to shear stress in the anti-icing fluid as shear stress is minimized. Also, the use of compressed air results in a compact but still relatively powerful anti-icing fluid sprayer.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the drawings:

FIG. 1, in a schematic view, illustrates an anti-icing fluid sprayer in accordance with an embodiment of the present invention;

FIG. 2, in a photograph, illustrates the anti-icing fluid sprayer shown in FIG. 1; and

FIG. 3, in a flow chart, illustrates a method of using the anti-icing fluid sprayer shown in FIGS. 1 and 2.

### DETAILED DESCRIPTION

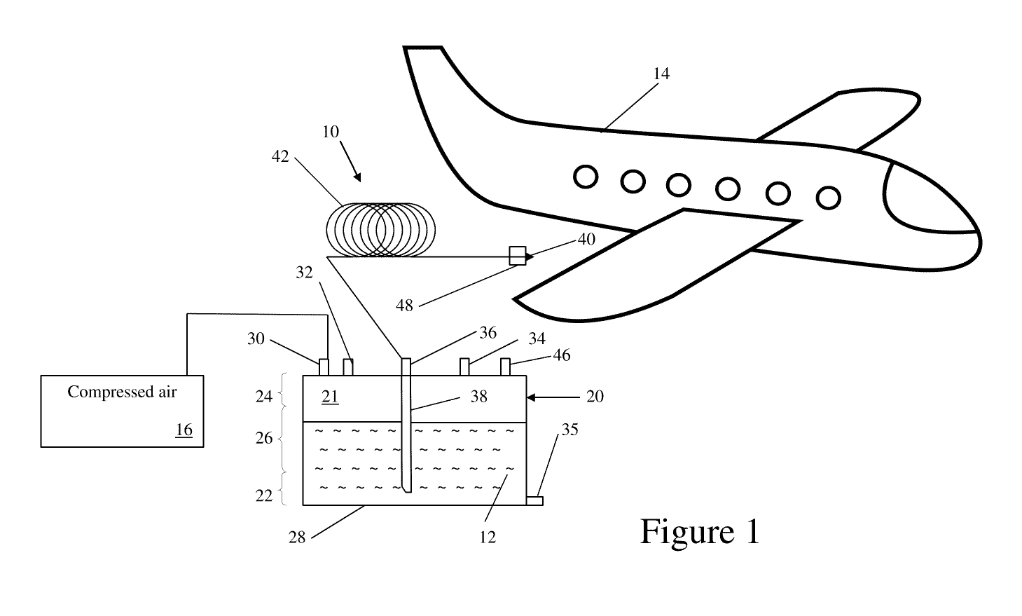

With reference to FIG. 1, there is shown an anti-icing fluid sprayer 10 for spraying airplane anti-icing fluid 12 on an airplane 14. The anti-icing fluid sprayer 10 uses a compressed air source 16. The anti-icing fluid sprayer 10 includes a tank 20 for holding the airplane anti-icing fluid 12, a spray gun 40 for spraying the airplane anti-icing fluid 12 and a hose 42 extending between the tank 20 and the spray gun 40. Pressurizing the tank 20 with compressed air 21 from the compressed air source 16 forces the airplane anti-icing fluid 12 out of the tank towards said spray gun 40.

The proposed anti-icing fluid sprayer 10 is particularly well suited to spray airplane anti-icing fluid 12 containing polymers and which are relatively easily degraded. These airplane anti-icing fluids 12 are known in the art as types II, III and IV. However, other anti-icing fluids, notably but not exclusively, shear stress sensitive anti-icing fluids, are also usable with the anti-icing fluid sprayer 10.

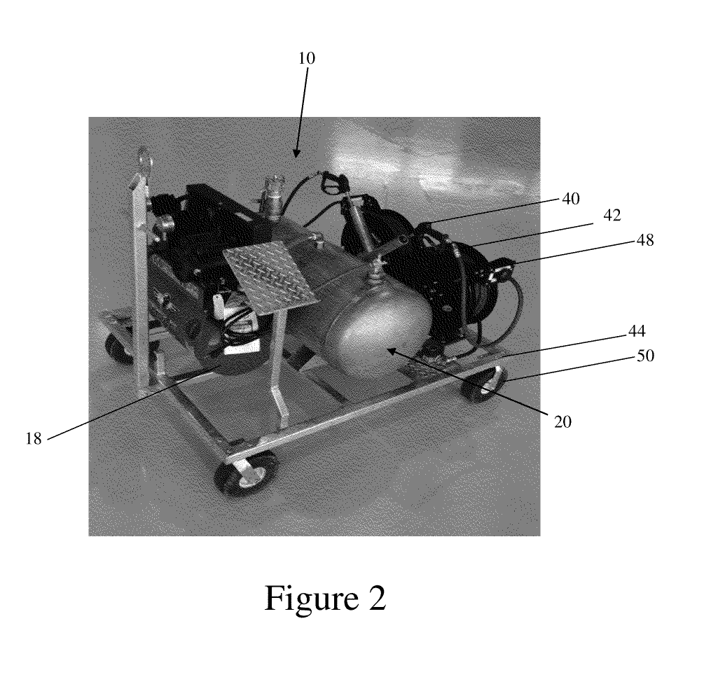

In some embodiments of the invention, the compressed air source 16 is a compressor 18 (as seen in FIG. 2), which may powered by fuel or electricity for example. However, in other embodiments, the compressed air source 16 may be a compressed air outlet provided in a building or any other compressed air source 16. Also, while typically the gas used is compressed air 21, it is within the scope of the invention to use any other suitable compressed gas, such a nitrogen, instead of the compressed air 21.

The tank 20 is made of suitable material, for example stainless steel, and defines a tank lower portion 22, a tank upper portion 24 and a tank intermediate 26 portion therebetween. The tank lower portion 22 also defines a tank lowest portion 28. For example, the tank 20 is substantially cylindrical and disposed with the longitudinal axis thereof substantially horizontal. The tank 20 defines tank air inlet and outlet 30 and 32 and tank fluid inlet and outlet 34 and 36. The tank air inlet and outlet 30 and 32 and tank fluid inlet and outlet 34 and 36 are typically provided in the tank upper portion 24, for example all at the top of the tank 20.

The tank air inlet 30 is connectable in fluid communication with the compressed air source 16 and is either permanently connected thereto or removably attachable thereto. Typically, the tank air inlet and outlet 30 and 32 are provided with suitable valves to allow selective passage of compressed air 21 therethrough. The tank air outlet 32 is used to release the pressure in the tank 20 for storage purposes or to allow refilling of the tank 20 with the airplane anti-icing fluid 12.

The tank fluid inlet 34 includes a cap that can be removed to introduce the airplane anti-icing fluid 12 in the tank 20. The tank fluid inlet 34 may also be provided with a safety valve that prevents sudden flow of compressed air 21 and/or airplane anti-icing fluid 12 out from the tank 20 is pressure has not been released when the cap is removed. In these embodiments, the tank fluid inlet 34 also serves as the tank air outlet 32. Also, in some embodiments, the tank further includes a tank emptying outlet 35, typically provided at the tank lowest portion 28, also including a cap and provided in the tank lower portion 22. The tank emptying outlet 35 is usable to empty the tank 20 after spraying the airplane anti-icing fluid 12 on the airplane 14 if required.

The tank fluid outlet 36 is connected with the hose 42 and may include also a manually actuated valve for selectively allowing passage of the airplane anti-icing fluid 12 between the tank 20 and the hose 42. The tank 20 includes a drawing tube 38 extending between the tank fluid outlet 36 and the tank lower portion 22. The drawing tube 38 extends typically to a location substantially adjacent the tank lowest portion 28, with only a relatively small gap remaining between the drawing tube 38 and the wall of the tank 20. The drawing tube 38 extends in a generally upward direction to the tank fluid outlet 36. For example the drawing tube 38 is substantially vertical. However, the drawings tube 38 may also be oblique. It has been found that the proposed configuration minimizes shear stress in the airplane anti-icing fluid 12 in use, which in turn preserves the chemical structure of polymer chains in the airplane anti-icing fluid 12. In some embodiments of the invention, the drawing tube 38 is about 0.5 to about 2 inches from the tank lower portion 22, for example 1 inch. In some embodiments of the invention, the lower portion of the drawing tube 38, from which the airplane anti-icing fluid 12 is drawn, is cut at an angle such that the formation of a vortex in the airplane anti-icing fluid 12 is substantially prevented when the airplane anti-icing fluid 12 is forced upwards into the drawing tube 38, which in turn minimizes any shear stress in the airplane anti-icing fluid 12 and preserves the chemical structure of polymer chains in the airplane anti-icing fluid 12. For example, this is achieved by having the bottom of the drawings tube 38 parallel to the tank 20, ie horizontal, along a portion thereof and the remainder thereof at an angle relative thereto, for example from about 30 to about 60 degrees, and in a specific example 45 degrees. Also, in some embodiments, the pressure of the compressed air 21 in the tank 20 averages between about 110 and about 130 PSI during operation of the anti-icing fluid sprayer 10.

The spray gun 40 is conventional in the art and will not be described in details herein. It has been found that a spray gun 40 produced in Italy by PA, model # RL26, which is tested up to 4050 PSI and can spray a maximum of 30 liters per minute (8 US gal per min) is well-suited for use in the present invention. This spray gun produces a jet 25 degrees wide with a 1.2 mm orifice which sprays about 6 liters of fluid per minute at the above-mentioned compressed air pressure (12 liters per minute when 2 spray guns 40 are in use). At the base of the spray gun 40, a swivel is found between the hose 42 and the spray gun 40, which allows for 360 degrees of motion without pinching and twisting the couplings or hose assembly.

In some embodiments, the anti-icing fluid sprayer 10 is also provided with a pressure gauge 46 for monitoring the pressure in the tank 20 and a flow meter 48 at the spray gun 40 for monitoring the quantity of the airplane anti-icing fluid 12 sprayed. Also, in some embodiments, more than one tank fluid outlet 36 is provided, each connected to a respective spray gun 40 and if included, flow meter 48.

In some embodiments, as seen in FIG. 2, the anti-icing fluid sprayer 10 includes a caddy 44 to which the compressor 18, tank 20, hose 42 and spray gun 40 are mounted. The caddy 44 may be provided with wheels 50.

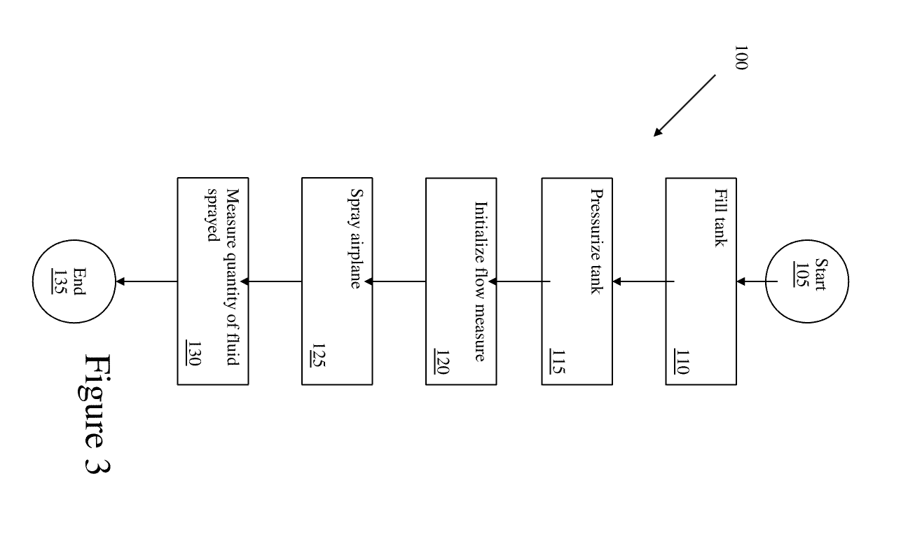

FIG. 3 illustrates a method 100 of using the anti-icing fluid sprayer 10. The method 100 starts at step 105. Then, at step 110, the tank 20 is partially or completely filled with the airplane anti-icing fluid 12 through the tank fluid inlet 34 and the tank fluid inlet 34 is capped. Afterward, at step 115, the tank 20 is pressurized using the compressed air source 16. For example, the compressor 18 is used to bring the pressure inside the tank 20 at a predetermined pressure and then stopped. In other embodiments, the compressor 18 monitors the pressure inside the tank 20 and starts and stops automatically to keep this pressure within a predetermined range.

Subsequently, at step 120, flow meter 48 measurements are initialized when a flow meter 48 is present. This is done by either resetting the flow meter 48 to zero or by noting a first value of cumulative flow meter 48 use. Then, at step 125 the airplane anti-icing fluid 12 is drawn from the tank 20 and sprayed on the airplane 14 using the spray gun 40. When enough airplane anti-icing fluid 12 has been sprayed, spraying is stopped and a measure of the quantity of fluid sprayed may be taken at step 130. This is performed by either reading directly a measure on the flow meter 48, or by subtracting a second value of cumulative flow meter use subsequent to spraying and subtracting therefrom the first value taken at step 120. Finally, the method ends at step 135.

### Example 1

Tests were conducted using a Misco Palm Abbe Digital refractometer model # PA202 and Clariant's Max Flight 04 Type IV fluid using anti-icing fluid sprayer 10 as described hereinabove. The procedure used was to take a first sample of the fluid prior to filling the tank 20. A second sample was taken from a large round container which was sprayed into from a distance of 10 feet minimum. The first sample had a viscosity of 36.3 Brix and the second sample, taken in the container after spraying, had also a viscosity of 36.3 Brix, which shows no degradation after passing through the anti-icing fluid sprayer 10.

### Example 2

A test was performed on a Gulfstream G650 Business Jet using the anti-icing fluid sprayer 10 as described hereinabove. The fluid used for this test was Kilfrost ABC-S Type IV and the same protocol was conducted. A first sample was taken prior to filling the tank 20 and the second sample was taken from the wing of the G650 after the spray was performed. The sample viscosity results were 35.9 Brix and 35.7 Brix respectively for the first and second samples, which shows a very slight reduction in the viscosity of the Kilfrost ABC-S Type IV after passing through the anti-icing fluid sprayer 10.

In addition, application of the fluid was timed. Some prior art devices used on the same airplane took up to 75 minutes to spray the Gulfstream G650 aircraft on a regular basis. Spraying with a device according to the invention took less than 15 minutes to spray the aircraft's wings & horizontal tail section. A total of 60 minutes was saved in the application time required to treat the Business jet, which in turn provides flight crews with substantially more holdover time to taxi and takeoff safely.

Although the present invention has been described hereinabove by way of preferred embodiments thereof, it can be modified, without departing from the spirit and nature of the subject invention as defined in the appended claims.

What is claimed is:

1. An anti-icing fluid sprayer usable with a compressed air source for spraying airplane anti-icing fluid on an airplane, said anti-icing fluid sprayer comprising:
a tank for holding said airplane anti-icing fluid, said tank defining a tank lower portion, a tank upper portion and a tank intermediate portion therebetween, said tank defining tank air inlet and outlet and tank fluid inlet and outlet, said tank fluid outlet being in said tank upper portion, said tank including a drawing tube extending between said tank fluid outlet and said tank lower portion, said tank air inlet being connectable to said compressed air source;
a spray gun for spraying said airplane anti-icing fluid; and
a hose extending between said tank fluid outlet and said spray gun;
whereby pressurizing said tank with compressed air from said compressed air source forces said airplane anti-icing fluid out of said tank towards said spray gun.

2. An anti-icing fluid sprayer as defined in claim 1, wherein said drawing tube has a beveled free end in said tank lower portion.

3. A method for spraying airplane anti-icing fluid on an airplane, said method comprising:
providing a tank in which said airplane anti-icing fluid is contained, said tank being pressurized with a gas;
drawing said anti-icing fluid from said tank under the action of pressure exerted by said gas; and
spraying said anti-icing fluid from said tank.
